(19) United States
(12) Patent Application Publication
(10) Pub. No.: US 2007/0027935 A1
(43) Pub. Date: Feb. 1, 2007

(54) Backing up source files in their native file formats to a target storage

(76) Inventors: William Robert Haselton, Peabody, MA (US); Christopher John Stakutis, Concord, MA (US); Kevin Michael Stearns, Maynard, MA (US)

Correspondence Address: KONRAD RAYNES & VICTOR, LLP.;ATTN: IBM37, 315 SOUTH BEVERLY DRIVE, SUITE 210, BEVERLY HILLS, CA, 90212, US

(21) Appl. No.: 11/193,280

(22) Filed: Jul. 28, 2005

(51) Int. Cl. G06F 17/30

(52) U.S. Cl. 707/204

(57) ABSTRACT

Provided are a method, system, and program for backing up source files in their native file formats to a target storage. Indication of files in a defined backup set to backup having a first status is maintained, wherein files to backup not having the first status have a second status. One file in a source file system in the defined backup set is detected to have changed. A determination is made as to whether the changed file has the first status. The changed file is written in its native file format to a target storage in response to determining that the changed file has the first status. The changed file is also written in its native file format to the target storage at a scheduled backup time.

### BACKGROUND OF THE INVENTION

1. Field of the Invention

The present invention relates to a method, system, and program for backing up source files in their native file formats to a target storage.

2. Description of the Related Art

Backup programs backup data at a computer system to a backup storage device, which may comprise a local storage device or remote storage device. Certain backup programs provide management of the backed up files and may utilize a backup database having information on the status of backed-up files. Such managed backup programs typically store the data in a proprietary storage format and utilize complex backup client and backup server programs to manage the backup operations in a network environment. The managed backup program must be used to restore the files maintained in the proprietary backup format.

Backup programs for home or small businesses use may include aspects of the managed backup program, and utilize a backup database and a proprietary file format. Replication or synchronization backup programs copy files in their native file format to a backup storage device to store the files in their native file format providing a mirrored file system. Such replication and synchronization backup programs typically may not use a backup database to manage the backed-up files and do not provide many of the backup management features offered by the managed backup programs. However, with the replication backup programs, the user may restore the files in their native file format in the backup storage without having to rely on the backup program to convert the backed-up files in the proprietary file format to the native file format.

### SUMMARY

Provided are a method, system, and program for backing up source files in their native file formats to a target storage. Indication of files in a defined backup set to backup having a first status is maintained, wherein files to backup not having the first status have a second status. One file in a source file system in the defined backup set is detected to have changed. A determination is made as to whether the changed file has the first status. The changed file is written in its native file format to a target storage in response to determining that the changed file has the first status. The changed file is also written in its native file format to the target storage at a scheduled backup time.

Further provided are a method, system, and program maintaining at a computer a defined backup set of files to backup in a source file system used by the computer to a target storage. A directory is created identifying the computer in a file system of the target storage. One file in the defined backup set is detected to have changed. The changed file is written in its native file format to the directory in the target storage identifying the computer as part of a backup operation, wherein the written changed file is in its native file format on the target storage.

### BRIEF DESCRIPTION OF THE DRAWINGS

FIG. 1 illustrates of an embodiment of a computing environment.

FIG. 2 illustrates an embodiment of backup settings used by a backup program.

FIG. 3 illustrates an embodiment of operations performed by a backup program to generate a user interface in which a user may enter backup settings for the backup program.

FIG. 4 illustrates an embodiment of a user interface in which a user enters backup setting information for the backup program.

FIG. 5 illustrates an embodiment of operations performed by a backup program to backup changed files.

FIG. 6 illustrates an embodiment of operations performed by a backup program to manage a size used by a local storage for backup files.

FIG. 7 illustrates an embodiment of operations performed by a backup program to perform a point-in-time restore operation.

FIG. 8 illustrates an embodiment of a network computing environment.

FIG. 9 illustrates an embodiment of operations performed by backup programs to backup changed files in the network computing environment.

### DETAILED DESCRIPTION

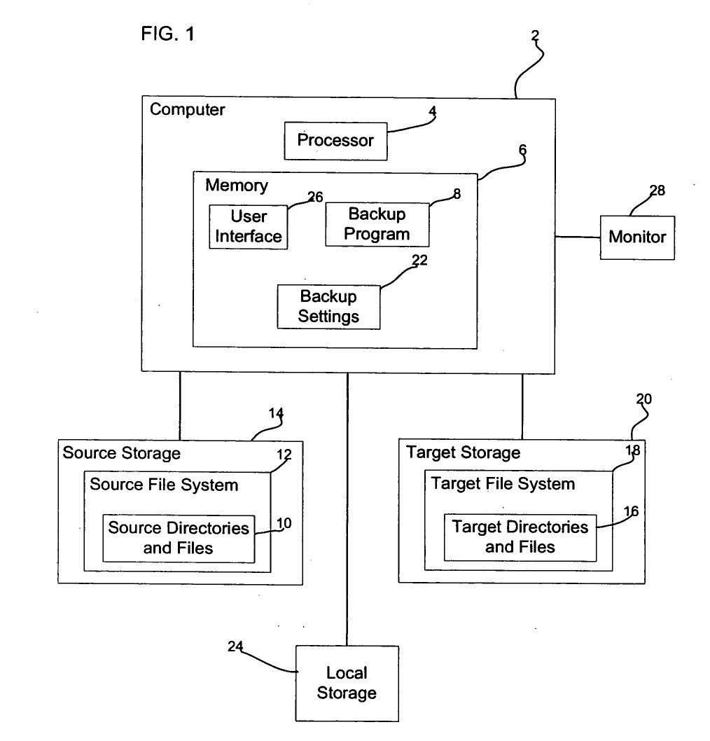

FIG. 1 illustrates a computing environment in which embodiments are implemented. A computer 2 includes a processor 4 and a memory 6 comprised of one or more memory devices including the programs and code executed by the processor 4. A backup program 8 executing in the memory 6 transfers source directories and files 10 in a source file system 12 in a source storage 14 to target directories and files 16 replicating the source directories and files 10 in a target file system 18 in a target storage 20. The backup program 8 is controlled by backup settings 22, including default settings and settings configured by a user of the backup program 8.

A local storage 24 is used by the backup program 8 to backup source directories and files 10 as part of the backup operations described below. The local storage 24 may be implemented in the same device as the source storage 14 or in a separate storage device. The source 14 and target 20 storages may be implemented in separate storage devices or in a same storage device or system.

The backup program 8 may generate a user interface 26 rendered on a computer monitor 28 in which the user may enter backup settings 22 to control the backup operations of the backup program 8.

The storages 14 and 20 may be implemented in storage devices known in the art, such as one hard disk drive, a plurality of interconnected hard disk drives configured as Direct Access Storage Device (DASD), Redundant Array of Independent Disks (RAID), Just a Bunch of Disks (JBOD), etc., a tape device, an optical disk device, a non-volatile electronic memory device (e.g., Flash Disk), etc.

In one embodiment, the target file system 18 replicates the backed-up source directories and files 10, such that the target directories and files 16 are in the native file format of the corresponding source directories and files 10 backed-up. Thus, the target files 16 may be directly accessed by the applications that created the files.

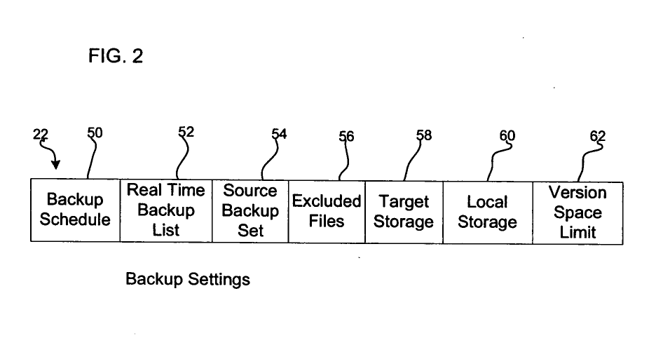

FIG. 2 illustrates an embodiment of information that may be included in the backup settings, including: a backup schedule 50 indicating times during which a backup operation occurs to write backed-up files to the target storage 20; a real time backup list 52 indicating source directories, files or file types 10 that are subject to real-time backup to the target storage 20 after the file is changed or modified; a source backup set 54 indicating the source directories and files 10 to include in the backup, which may comprise a directory path or an entire logical device, e.g., the “c” drive; excluded files 56 indicating files, directories and/or file types in the source file system 12 to exclude from the backup; a target storage 58 indicating the device or directory location in a device to which the source files are replicated; a local storage 60 indicating the device or directory location of the local storage 24 to which files are backed-up; and a version space limit 62 indicating a maximum amount of storage space allocated to the local storage 24 to store backed up files and different versions of files

In certain embodiments, the backup program 8 may maintain versions of backed-up files in the local storage 24, up to some user designated maximum number of versions. Thus, when a file, e.g., “file.txt” is modified, a suffix indicating a version number, e.g., “v1”, “v2”, etc., is appended to the most recent version of the file, e.g., “file.txt.v1”, “file.txt.v2”, etc., so that the changed file has the file name without the version information, .e.g., “file.txt”, which is the active version of the file. Once the local storage 24 reaches the version space limit, the backup program 8 may start deleting the oldest versions of files to keep the size of the local storage 24 below the space limit 62.

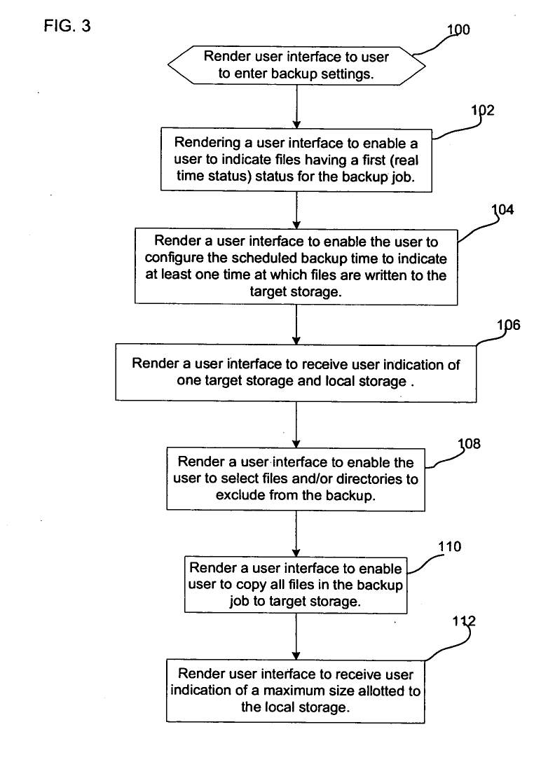

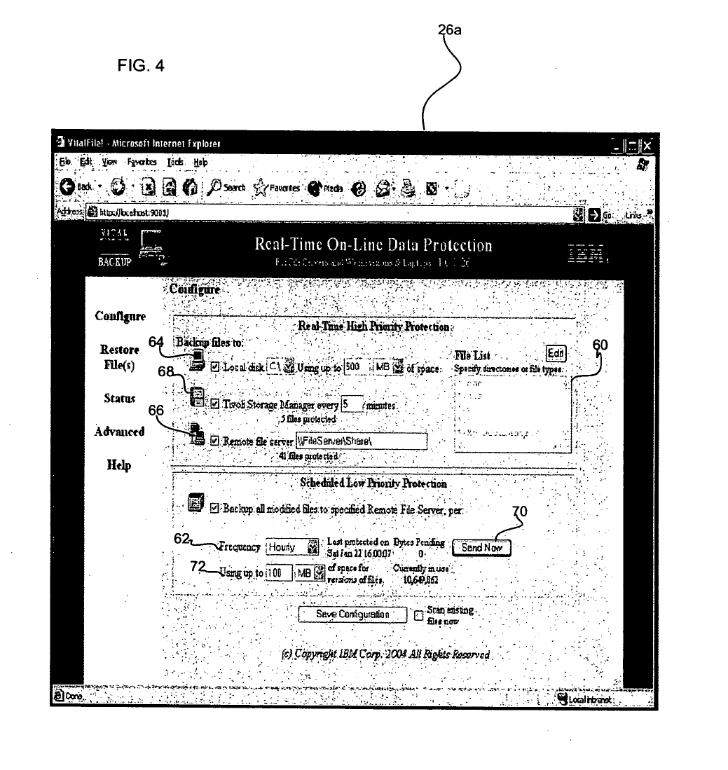

FIG. 3 illustrates operations performed by the backup program 8 to present one or more instances of the user interfaces 26 in which the user may enter backup settings 22. Upon beginning (at block 100) operations to render a user interface 26, the backup program 8 may render (at block 102) a user interface 26 to enable a user to indicate files having a first (real time status) status 52 for the backup job. FIG. 4 illustrates an example of a user interface panel 26a having an entry window 60 in which the user may indicate files, directories and/or file types having a real time status, such that these indicated files, directories of files and or file types are written to the target storage 20 immediately after being changed. A modification may occur when the user or program saves the file. The backup program 8 renders (at block 104) a user interface to enable the user to configure the scheduled backup time 50 to indicate at least one time at which all files in the defined backup set are written to the target storage 20, including files having the real-time, high priority status and all other files having a lower priority. FIG. 4 illustrates an example of a scheduler selector 62 in which the user can select a time period or frequency at which backup operations are performed to copy source files and directories from the local storage 24 to the target storage 20, e.g., hourly, daily, weekly, every other day, etc.

At block 106, the backup program 8 renders a user interface 26 to receive user indication of a device, directory, etc. of the target storage 20 and local storage 24. FIG. 4 illustrates an example of the user interface 26a having a local storage selection field 64 in which the user indicates the location of the local storage 24 and a target storage field 66 in which the user indicates the location (directory, device, etc.) of the target storage 20. The user interface 26a further shows an additional target storage 68 to which backup data may be written, such as an entirely different backup server.

At block 108, the backup program 8 renders a user interface 26 to enable the user to select files and/or directories in the source file system 12 to exclude from the defined backup set.

At block 110, the backup program 8 renders a user interface 26 to enable the user to cause the backup program 8 to copy all files in the defined backup set 56 to the target storage 20. FIG. 4 illustrates an example of the user interface 26a having a “send now” button 70, whose selection causes the backup program 8 to copy all files in the defined backup set 54 to the target storage 20 so that the target storage 20 provides a complete replication of the source directories and files 10 indicated in the defined backup set 54. After performing the scheduled backup, the local storage 24 may be cleared.

At block 112, the backup program 8 renders a user interface 26 to receive user indication of a maximum size allotted to the local storage 24, i.e., the version space limit 62. FIG. 4 provides an example of user interface elements 72 in which the user may indicate the maximum size to use for the local storage 24 before the oldest versions of the file are deleted to maintain the space used by the local storage 24 below the limit.

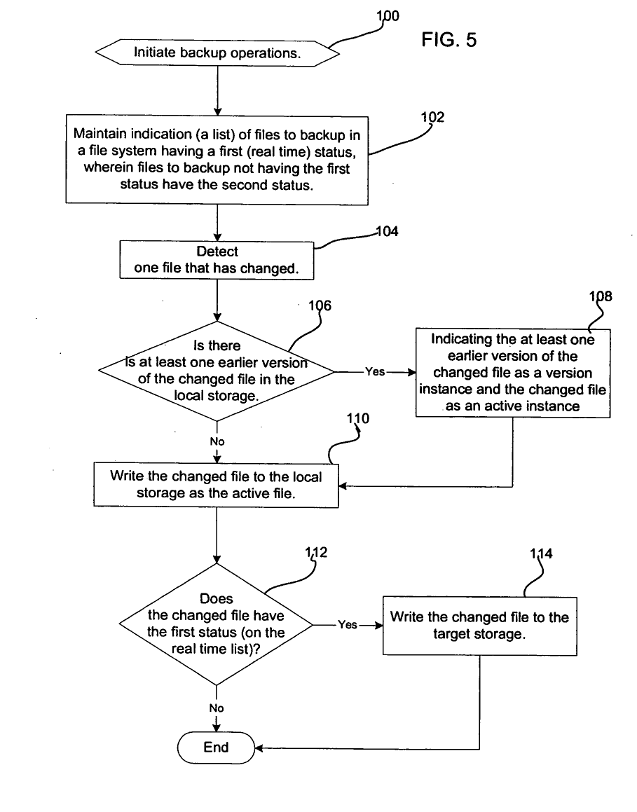

FIG. 5 illustrates operations performed by the backup program 8 to perform backup operations in response to a modification to a file in the source backup set 54. A full replication of the source directories and files 10 may have been previously performed, such as by previously selecting the “send now” button 70 (FIG. 4). As part of backup operations (at block 100), the backup program 8 maintains (at block 102) indication, e.g., the real time backup list 52, of files to backup in the source file system 12 having a first (real time) status. Files in the defined backup set not having the first status may be assumed to have a lower priority (second) status. In response to detecting (at block 104) a change to a file in the defined backup set 54, if (at block 106) there is at least one earlier version of the changed file in the local storage 24, then the backup program 8 indicates (at block 108) the at least one earlier version of the changed file as a version instance (e.g., “file.txt.v2”) and the changed file as an active instance (e.g., “file.txt”). If there are no earlier versions (the no branch of block 106) or after updating the version instances (at block 108), the backup program 8 writes (at block 110) the changed file to the local storage 24 as the active file. If (at block 112) the changed file has the first (real-time or high) status (e.g., on the real time list 52), then the backup program 8 also writes (at block 114) the changed file to the target storage 20. As discussed, the backup program 8 writes the files to the target 20 and local 24 storages in their native file format.

With the described embodiment of operations of FIG. 5, the backup program 8 maintains all changed files in the local storage 24 and immediately writes changed files having the high (real-time) priority to the target storage 20. All changed files in the local storage 24 are written during their scheduled backup time 50 to the target storage 20. After a scheduled backup of all the changed files in the local storage 24, the local storage may be cleared. In this way, the local storage 24 provides a temporary local storage for changed files before they are written to the target storage 20.

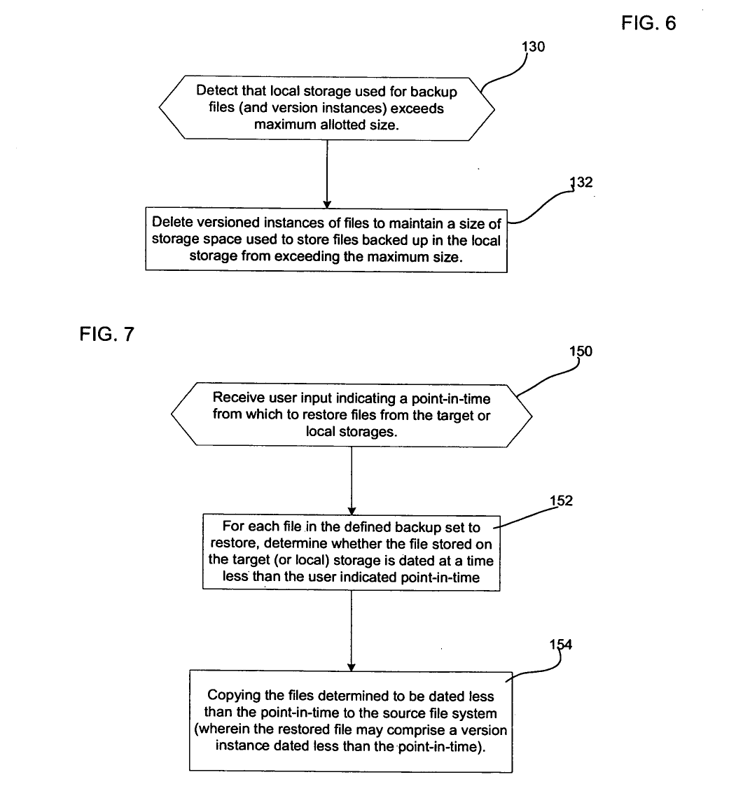

FIG. 6 illustrates operations performed by the backup program 8 in response to detecting (at block 130) that the local storage 24 used for backup files (and version instances) exceeds the maximum allotted size, i.e., version space limit 62. The backup program deletes (at block 132) versioned instances of the backed-up files in the local storage 24 to ensure that the size of the local storage 24 does not exceed the maximum size. Different selection techniques may be used for selecting versioned instances to delete, such as by deleting the oldest versions and lower priority versions first.

FIG. 7 illustrates operations performed by the backup program 8 to perform a point-in-time restore operation. Upon receiving (at block 150) user input indicating a point-in-time from which to restore files in the target storage 20 or the local storage 24 (the user may select either or both), the backup program 8 determines (at block 152), for each file in the defined backup set 54 to restore, whether the file stored on the target 20 (or local 24) is dated at a time less than the user indicated point-in-time. The restore operation may indicate to restore all files indicated in the source backup set 54 or a subset thereof. The backup program 8 copies (at block 154) the files determined to be dated less than the point-in-time to the source file system 12. The restored files may comprise a version instance dated less than the point-in-time. If there are multiple version instances of the file to restore, then the version instance restored as the active instance comprises the version instance closest and not greater than the point-in-time of the restore. In this way, the operations of FIG. 7 provide a point-in-time restore of a replicated backup having files in their native file format as of a previous time, e.g., last Tuesday.

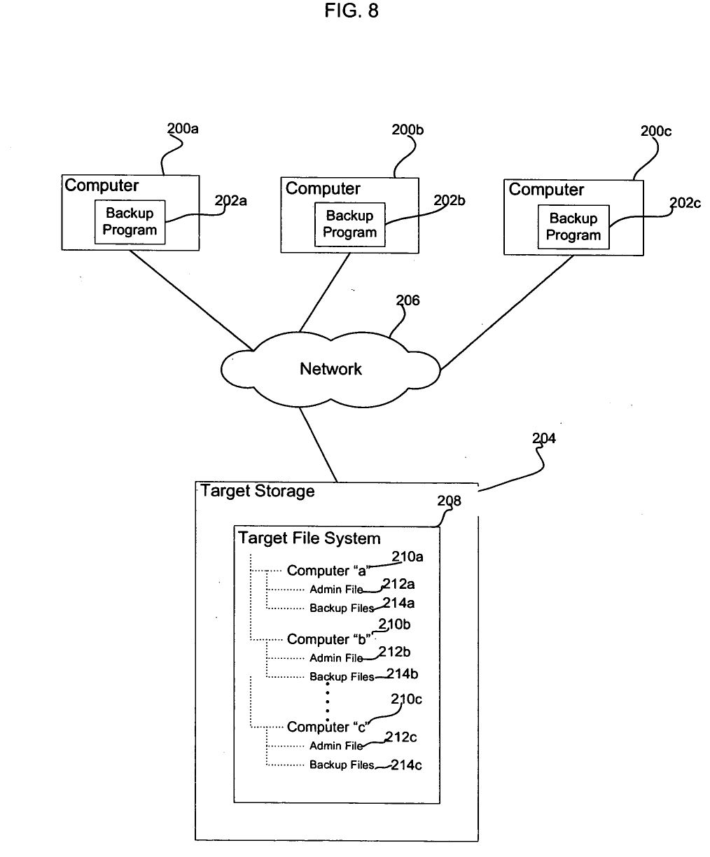

FIG. 8 illustrates a network environment in which multiple computers 200a, 200b, 200c include the backup program 202a, 202b, 202c that may perform the backup operations described above with respect to FIGS. 1-7, to backup their local source file systems to a target storage 204 over a network 206. The computers 200a, 200b, 200c may include the components shown in FIG. 1 and there may be more or fewer computers having backup programs than shown in FIG. 8. The network 206 may comprise a Local Area Network (LAN), Storage Area Network (SAN), Wide Area Network (WAN), wireless network, etc. The target storage 204 includes a target file system 208 to which each computer 200a, 200b, 200c writes its backup data sets 54 and changed files according to the backup operations described above. In one embodiment, each backup program 202a, 202b, 202c when writing to a network target storage 204 may create a computer specific directory 210a, 210b, 210c identifying the computer 200a, 200b, 200c. All of the files to backup 212a, 212b, 212c for the computers 200a, 200b, 200c are written into that computer specific directory 210a, 210b, 210c. Each backup program 202a, 202b, 202c writing to one specific computer specific directory 210a, 210b, 210c associated with the computer 200a, 200b, 200c on which the backup program is running may store status information on the status of backup operations in an administrative file 214a, 214b, 214c.

The target storage 204 may comprise a storage device accessible over a network, such as a network attached storage (NAS), a server managing one or more interconnected hard disk drives, an enterprise storage server, a computer having one or more hard disk drives, a tape storage, etc.

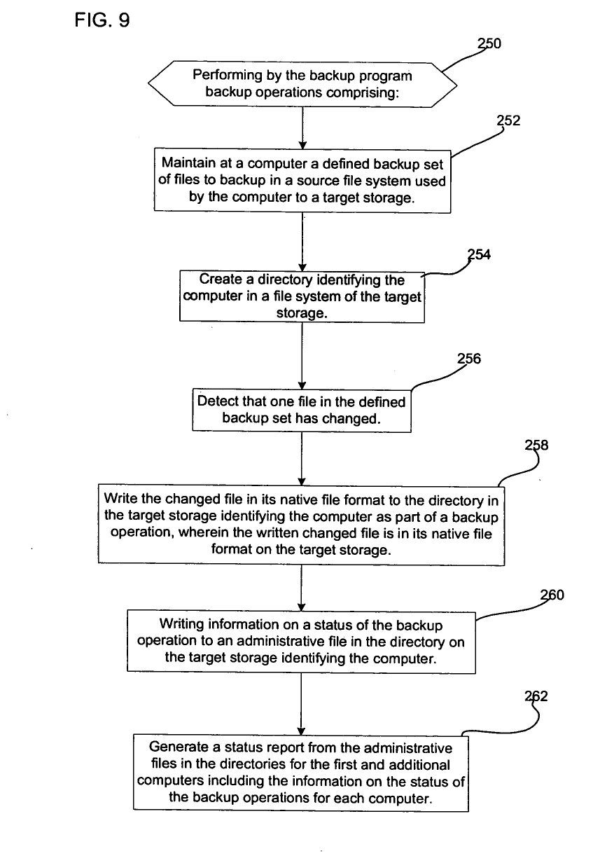

FIG. 9 illustrates backup operations independently performed by the backup programs 202a, 202b, 202c. As part of the backup operations (at block 250), the backup program 202a, 202b, 202c maintains (at block 252) at the computer 200a, 200b, 200c in which it is executing a defined backup set 54 (FIG. 2) of files to backup in the source file system of the computer 200a, 200b, 200c or in a device attached to the computer 200a, 200b, 200c to the target storage 204. The backup program 202a, 202b, 202c creates (at block 254) a computer specific directory 210a, 210b, 210c identifying the computer 200a, 200b, 200c, such as the computer name, in the target file system 208 of the target storage 204. In response to detecting (at block 256) that one file in the defined backup set 54 has changed, the backup program 202a, 202b, 202c writes (at block 258) the changed file in its native file format to the directory 210a, 210b, 210c in the target storage 204 identifying the computer as part of a backup operation. The backup program 202a, 202b, 202c further writes (at block 260) information on a status of the result of the backup operation to an administrative file 214a, 214b, 214c in the computer specific directory 210a, 210b, 210c.

Each of the backup programs 202a, 202b, 202c may process the administrative files 212a, 212b, 212c to generate (at block 262) a status report from the administrative files 212a, 212b, 212c in the directories 210a, 210b, 210c for multiple computers aggregating the information on the status of the backup operations for each computer 200a, 200b, 200c. The status information may indicate a time of the backup operation, the duration of the operation, completion time, results of the backup, etc.

With the described embodiments of FIGS. 8 and 9, multiple computers in a network may independently backup files in their native file format to a target storage accessible over the network. Further, the described system is scalable, such that if a new computer starts providing backups, its backups are written to a computer specific directory 210a, 210b, 210c that does not overlap or interfere with other directories in the target file system 208. In this way, the backup programs 202a, 202b, 202c operate independently to provide managed backup of the file systems on the different computers 200a, 200b, 200c.

The described embodiments provide a replication of files to backup in their native file format to a target storage and management of the backup to allow for high priority (real-time) versus low priority file handling and for the backup of source files in multiple computers in a network.

### Additional Embodiment Details

The described operations may be implemented as a method, apparatus or article of manufacture using standard programming and/or engineering techniques to produce software, firmware, hardware, or any combination thereof. The term “article of manufacture” as used herein refers to code or logic implemented in a medium, where such medium may comprise hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks,, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The medium in which the code or logic is encoded may also comprise transmission signals propagating through space or a transmission media, such as an optical fiber, copper wire, etc. The transmission signal in which the code or logic is encoded may further comprise a wireless signal, satellite transmission, radio waves, infrared signals, Bluetooth, etc. The transmission signal in which the code or logic is encoded is capable of being transmitted by a transmitting station and received by a receiving station, where the code or logic encoded in the transmission signal may be decoded and stored in hardware or a computer readable medium at the receiving and transmitting stations or devices. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

FIG. 4 provides an example of a user interface layout in which the user may enter backup program settings. In alternative embodiments, different user interface elements may be provided to the user to enter backup settings or the user interface elements enabling user entry of settings may be presented in separate user interface windows or panels.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

In certain embodiments, the file sets and metadata are maintained in separate storage systems and commands to copy the file sets and metadata are transmitted by systems over a network. In an alternative embodiment, the file sets and metadata may be maintained in a same storage system and the command to copy may be initiated by a program in a system that also directly manages the storage devices including the file sets and metadata to copy.

The illustrated operations of FIGS. 3, 5, 6, 7, and 9 shows certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method, comprising:
maintaining indication of files in a defined backup set to backup having a first status, wherein files to backup not having the first status have a second status;
detecting that one file in a source file system in the defined backup set has changed;
determining whether the changed file has the first status;
writing the changed file in its native file format to a target storage in response to determining that the changed file has the first status; and
writing the changed file in its native file format to the target storage at a scheduled backup time.

2. The method of claim 1, further comprising:
rendering a first user interface to enable a user to indicate files having the first status; and
rendering a second user interface to enable the user to configure the scheduled backup time at which changed files are written to the target storage.

3. The method of claim 1, further comprising:
receiving user indication of the target storage and a local storage, wherein files having the first status are written to the target and local storages in response to detecting the change to the files, and files having the second status are written to the local storage in response to detecting the change to the files and to the target storage according to the scheduled backup time.

4. The method of claim 3, further comprising:
determining whether there is at least one earlier version of the changed file in the local storage;
indicating the at least one earlier version of the changed file as a version instance and the changed file as an active instance;
writing the file to the local storage as an active version in response to determining that there is an earlier version of the file in the local storage;
receiving user indication of a maximum size allotted to the local storage; and
deleting versioned instances of files to maintain a size of storage space used to store files backed up in the local storage from exceeding the maximum size.

5. The method of claim 1, further comprising:
receiving user input indicating a point-in-time from which to restore files in the defined backup set from the target storage;
for each file in the defined backup set to restore, determining whether the file stored on the target file system is dated at a time less than the user indicated point-in-time; and
copying the files determined to be dated less than the point-in-time from the target storage to the source file system, wherein at least one of the files comprises one of a plurality of version instances of the file dated less than the point-in-time.

6. A method, comprising:
maintaining at a computer a defined backup set of files to backup in a source file system used by the computer to a target storage;
creating a directory identifying the computer in a file system of the target storage;
detecting that one file in the defined backup set has changed;
writing the changed file in its native file format to the directory in the target storage identifying the computer as part of a backup operation, wherein the written changed file is in its native file format on the target storage.

7. The method of claim 6, further comprising:
writing information on a status of the backup operation to an administrative file in the directory on the target storage identifying the computer.

8. The method of claim 6, wherein the computer comprises a first computer, and wherein at least one additional computer performs the operations of claim 6.

9. The method of claim 8, wherein the first computer and additional computers each perform:
writing information on a status of the backup operations to an administrative file in the directory identifying the computer; and
generating a status report from the administrative files in the directories for the first and additional computers including the information on the status of the backup operations for each computer.

10. A system, comprising:
a processor;
a source file system;
a target storage storage;
a computer readable medium including code executed by the processor to perform operations, the operations comprising:
maintaining indication of files in a defined backup set to backup having a first status, wherein files to backup not having the first status have a second status;
detecting that one file in the source file system in the defined backup set has changed;
determining whether the changed file has the first status;
writing the changed file in its native file format to the target storage in response to determining that the changed file has the first status; and
writing the changed file in its native file format to the target storage at a scheduled backup time.

11. The system of claim 10, wherein the operations further comprise:
rendering a first user interface to enable a user to indicate files having the first status; and
rendering a second user interface to enable the user to configure the scheduled backup time at which changed files are written to the target storage.

12. The system of claim 10, further comprising:
a local storage;
wherein the operations further comprise receiving user indication of the target storage and the local storage, wherein files having the first status are written to the target and local storages in response to detecting the change to the files, and files having the second status are written to the local storage in response to detecting the change to the files and to the target storage according to the scheduled backup time.

13. The system of claim 12, wherein the operations further comprise:
determining whether there is at least one earlier version of the changed file in the local storage;
indicating the at least one earlier version of the changed file as a version instance and the changed file as an active instance;
writing the file to the local storage as an active version in response to determining that there is an earlier version of the file in the local storage;
receiving user indication of a maximum size allotted to the local storage; and
deleting versioned instances of files to maintain a size of storage space used to store files backed up in the local storage from exceeding the maximum size.

14. The system of claim 10, wherein the operations further comprise:
receiving user input indicating a point-in-time from which to restore files in the defined backup set from the target storage;
for each file in the defined backup set to restore, determining whether the file stored on the target file system is dated at a time less than the user indicated point-in-time; and
copying the files determined to be dated less than the point-in-time from the target storage to the source file system, wherein at least one of the files comprises one of a plurality of version instances of the file dated less than the point-in-time.

15. A system, comprising:
a processor;
a source file system;
a target storage storage;
a computer readable medium including code executed by the processor to perform operations, the operations comprising:
maintaining a defined backup set of files to backup in the source file system to the target storage;
creating a directory identifying the system in a file system of the target storage;
detecting that one file in the defined backup set has changed;
writing the changed file in its native file format to the directory in the target storage identifying the system as part of a backup operation, wherein the written changed file is in its native file format on the target storage.

16. The system of claim 15, wherein the operations further comprise:
writing information on a status of the backup operation to an administrative file in the directory on the target storage identifying the system.

17. The system of claim 15, wherein multiple systems each perform the operations of claim 6 and each write changed files and information on the status of backup operations to one directory on the target storage uniquely identifying that system, wherein the operations further comprise.
generating a status report from the administrative files in the directories for the systems including the information on the status of the backup operations for each system.

18. An article of manufacture including code in communication with a source file system and a target storage, wherein the code causes operations to be performed, the operations comprising:
maintaining indication of files in a defined backup set to backup having a first status, wherein files to backup not having the first status have a second status;
detecting that one file in the source file system in the defined backup set has changed;
determining whether the changed file has the first status;
writing the changed file in its native file format to the target storage in response to determining that the changed file has the first status; and
writing the changed file in its native file format to the target storage at a scheduled backup time.

19. The article of manufacture of claim 18, wherein the operations further comprise:
rendering a first user interface to enable a user to indicate files having the first status; and
rendering a second user interface to enable the user to configure the scheduled backup time at which changed files are written to the target storage.

20. The article of manufacture of claim 18, wherein the code is further in communication with a local storage, and wherein the operations further comprise:
receiving user indication of the target storage and the local storage, wherein files having the first status are written to the target and local storages in response to detecting the change to the files, and files having the second status are written to the local storage in response to detecting the change to the files and to the target storage according to the scheduled backup time.

21. The article of manufacture of claim 20, wherein the operations further comprise:
determining whether there is at least one earlier version of the changed file in the local storage;
indicating the at least one earlier version of the changed file as a version instance and the changed file as an active instance;
writing the file to the local storage as an active version in response to determining that there is an earlier version of the file in the local storage;
receiving user indication of a maximum size allotted to the local storage; and
deleting versioned instances of files to maintain a size of storage space used to store files backed up in the local storage from exceeding the maximum size.

22. The article of manufacture of claim 18, wherein the operations further comprise:
receiving user input indicating a point-in-time from which to restore files in the defined backup set from the target storage;
for each file in the defined backup set to restore, determining whether the file stored on the target file system is dated at a time less than the user indicated point-in-time; and
copying the files determined to be dated less than the point-in-time from the target storage to the source file system, wherein at least one of the files comprises one of a plurality of version instances of the file dated less than the point-in-time.

23. An article of manufacture including code executed in a computer in communication with a source file system and a target storage, wherein the code causes operations to be performed, the operations comprising:
maintaining at the computer a defined backup set of files to backup in the source file system used by the computer to the target storage;
creating a directory identifying the computer in a file system of the target storage;
detecting that one file in the defined backup set has changed;
writing the changed file in its native file format to the directory in the target storage identifying the computer as part of a backup operation, wherein the written changed file is in its native file format on the target storage.

24. The article of manufacture of claim 23, wherein the operations further comprise:
writing information on a status of the backup operation to an administrative file in the directory on the target storage identifying the computer.

25. The article of manufacture of claim 23,, wherein the code is executed by a plurality of computers to perform the operations of claim 23 on the computers, wherein each computer executing the code writes changed files and information on the status of backup operations to the directory on the target storage uniquely identifying that computer, wherein the operations further comprise:
generating a status report from the administrative files in the directories for the systems including the information on the status of the backup operations for each computer.
